(19) United States
(12) Patent Application Publication
(10) Pub. No.: US 2005/0206297 A1
(43) Pub. Date: Sep. 22, 2005

(54) Luminous display device with increased active display and method of making the same

(75) Inventor: Perry H. Monitto, Setauket, NY (US)

Correspondence Address: DILWORTH & BARRESE, LLP, 333 EARLE OVINGTON BLVD., UNIONDALE, NY, 11553, US

(73) Assignee: MULTIMEDIA ELECTRONICS, INC., Farmingdale, NY (US)

(21) Appl. No.: 10/803,687

(22) Filed: Mar. 18, 2004

(51) Int. Cl. H01J 1/62

(52) U.S. Cl. 313/493; 313/609

(57) ABSTRACT

A luminous display device with a decreased inactive display area, thereby enabling an active display area of the device to be larger, and a method for making the same. The device includes a first and second circular plates being fused at an outer edge and having a diameter (D); a recess provided on an inner surface of the plates to define an interior portion surrounded by an outer rim with a width (W); a layer of beads held in position in the recess by the first and second fused plates and the outer rim; an ionizable gas filling a volume of the recess around the layer of beads; an electrode in communication with the ionizable gas for receiving a high frequency voltage and creating a lightning-like effect, which is visible in an active display of the first and second plates. A diameter of the active display is defined by D-2W and is at least 90% of the overall diameter of the plates.

### BACKGROUND OF THE INVENTION

1. Field of the Invention

The present invention relates generally to luminous display devices, and more particularly to a luminous display device with an increased active display area and a method for making the same.

2. Description of the Related Art

Luminous display devices are widely used for decorative or attention-getting purposes. The most common are probably those that are made up of simple or complex lengths of tubing filled with an inert gas such as neon, argon, mercury vapor, or mixtures thereof. Also rather common are flat display devices, which may serve as lighted signs having at least one transparent surface, which may be masked to create letters, figures, or characters. Generally, these include a combination of flat plates, which are spaced from each other to form a chamber, which is evacuated and then filled with the desired inert gas. Electrodes are arranged in such a manner as to set up a discharge path or paths in the chamber, and voltage is applied to cause ionization of the gas to produce a color display.

In the prior art, a rather conventional type of flat display device includes three glass or plastic plates fused together to form a sandwich. FIGS. 1-3 illustrate various views of the conventional luminous display device as taught in the prior art.

Referring to FIGS. 1-3, the outer plates 101 and 102 are continuous planes and the central plate 103 has a major portion of its central part removed, thereby forming a chamber 105 for containing the desired inert gas. A quantity of beads 106 fills the interior chamber 105 and serves as a separator for maintaining the space between the plates and provides a multitude of discharge channels for the electrical discharge 107 produced by a power supply 108 of radio frequency voltage that is fed by an electrode 109 to the interior chamber 105.

A tubular element 110 attached centrally to one of the outer plates (here, in plate 102) at a hole therethrough is used to evacuate the interior chamber 105 and introduce an inert gas into the chamber 105. The electrode 109 is then mounted in the tubular element 110 in a contacting relationship with the gas. When voltage is supplied through the electrode 109, the gas is ionized and produces fingers of light 107 extending radially outward from the center in the channels (or spaces) between the bead 106s, thereby resulting in the desired display.

However, a major drawback of the conventional flat display device is the rather large inactive display area 120. That is, in the conventional flat display device, due to the structural limitations of the three plate (101-103) design, the inactive display region 120 must be rather large, thereby limiting the size of the active display area 130. Typically, known prior art devices provide an active display area whose diameter is only 75-80% of the diameter of the entire device, and whose surface area is only 50-50% of the surface area of the entire device. More specifically, when the central plate 103 has most of its center portion removed, leaving a thin outer rim, which represents the inactive display 120, many production problems occur because the central plate 103 cannot physically support this design. As a result, in the conventional flat display device, the size of the active display area 130 is limited by the necessary size of the inactive display area 120. That is, as the overall diameter of the plate increases the inactive display area also must increase, resulting in a plate design that is not aesthetically pleasing to look at.

### SUMMARY OF THE INVENTION

Accordingly, the present invention has been designed to solve the above-described problems occurring in the prior art.

It is, therefore, an object of the present invention to provide a luminous display device with a decreased inactive display area, thereby providing a large an active display area of the device, and a method for making the same.

According to one aspect of the present invention, a luminous display device with an increased active display area is provided. The device comprises: a first and second circular plates fused at an outer edge and having a diameter (D); a recess provided on an inner surface of at least one the first and second plates to define an interior portion surrounded by an outer rim with a width (W); a layer of beads held in position in the recess by the first and second fused plates and the outer rim; an ionizable gas filling a volume of the recess around the layer of beads; an electrode in communication with the ionizable gas; and a power supply for providing a high frequency voltage applied to the electrode for creating a lightning-like effect, which is visible in an active display of the first and second plates, in the ionizable gas as multiple discharge paths through the layer of beads. Preferably, a diameter of the active display is at least 90% of the diameter of the entire luminous display device, and a surface of the active display is preferably 80-90% of the surface area of the entire device.

According to another aspect of the present invention a method of providing a luminous display device with an increased active display area is disclosed. The method comprises: providing a first and second circular plates having a diameter (D); creating a recess on an inner surface of at least one the first and second plates to define an interior portion surrounded by an outer rim with a width (W); filling the recess with a layer of beads; fusing the first and second plates to each other at an outer edge thereof, filling a volume of the recess around the layer of beads with an ionizable gas; installing an electrode in communication with the ionizable gas; and providing a high frequency voltage applied to the electrode for creating a lightning-like effect, which is visible in an active display of the first and second plates, in the ionizable gas as multiple discharge paths through the layer of beads. A diameter of the active display is defined by D-2W, and is at least 90% of the diameter of the entire luminous display device.

### BRIEF DESCRIPTION OF THE DRAWINGS

The above and other objects, features and other advantages of the present invention will be more clearly understood from the following detailed description taken in conjunction with the accompanying drawings, in which:

FIG. 1 a front plan view illustrating a conventional three plate luminous display device;

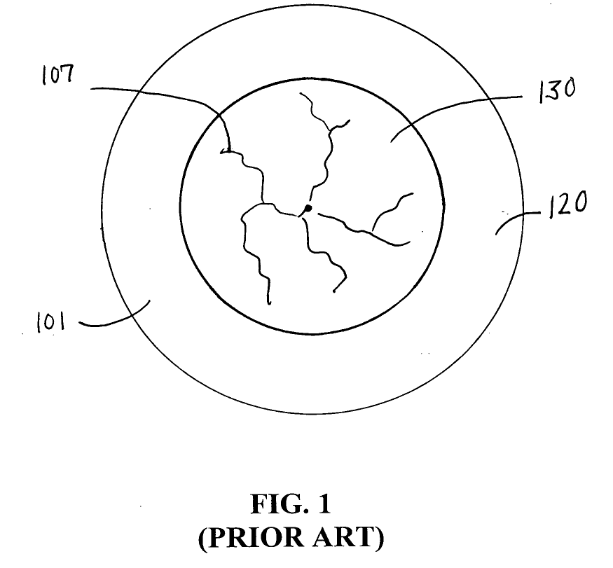

FIG. 2 is a rear view illustrating a housing of a power supply of the conventional three plate luminous display device;

FIG. 3 is a side sectional view illustrating the conventional three plate luminous display device;

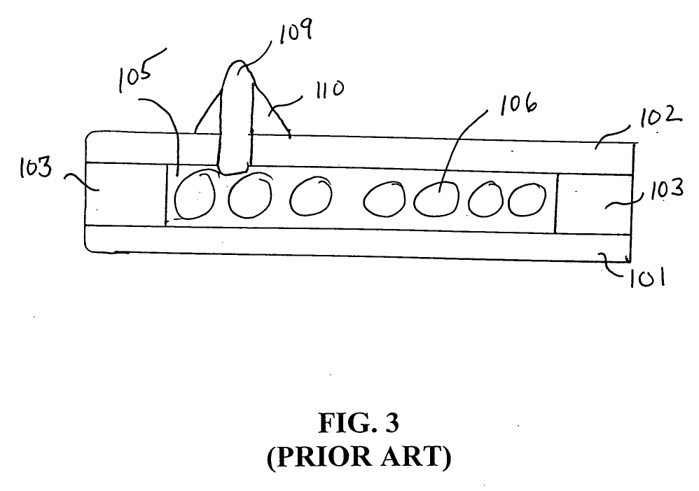

FIG. 4 is a front plan view of a luminous display device according to the present invention;

FIG. 5 is a schematic perspective view illustrating a two plate design structure of a luminous display device according to the present invention;

FIG. 6 is a side sectional view illustrating a two plate design structure of a luminous display device, wherein one of the two plates is provided with a recess;

FIG. 7 is a side sectional view illustrating a two plate design structure of a luminous display device, wherein each of the two plates is provided with a recess;

FIG. 8 is a front plan view illustrating a two plate design structure of a luminous display device according to the present invention including a layer of beads having different color phosphorescent coatings; and

FIG. 9 is a rear view illustrating a housing of a power supply for use with a two plate design structure of a luminous display device according to the present invention.

### DETAILED DESCRIPTION OF THE DRAWINGS

Preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may obscure the subject matter of the present invention.

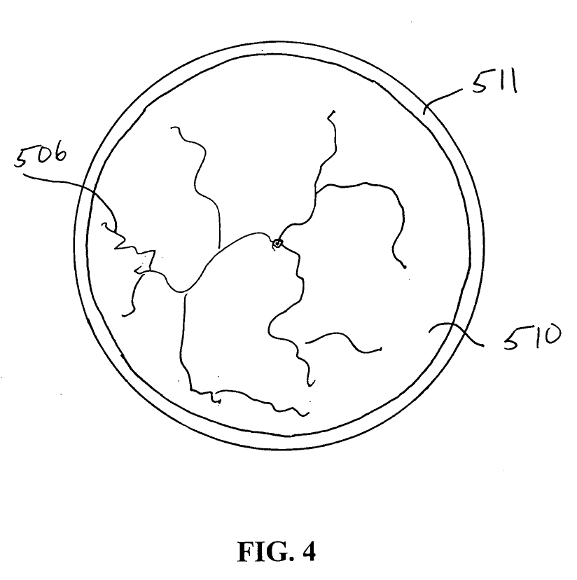

FIGS. 4 to 9 are various views illustrating different embodiments of a luminous display device according to the present invention. Detailed descriptions of the preferred embodiments of the present invention will now be given herein below with reference to FIGS. 4 to 9.

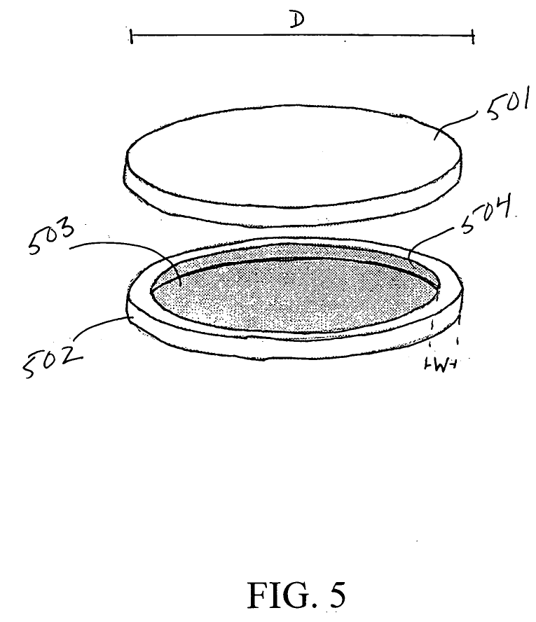

FIG. 5 is a schematic perspective view illustrating a two plate design structure of a luminous display device according to the present invention. As illustrated in FIG. 5, the luminous display device according to the present invention is constructed of two plates 501 and 502 having a circular shape. The plates 501 and 502 are preferably glass plates, but could also be fabricated of any other suitable material such as a plastic. Further, the plates 501 and 502 have a same diameter (D), and at least one plate is provided with a recess (or cavity) 503 on one surface to define an interior portion surrounded by an outer rim 504. According to one embodiment of the present invention, the outer rim 504 has a width (W) between a range of 0.35 to 0.6 inches. Preferably, the diameter of plates 501 and 502 is between 11.5 and 12.0 inches, and in a preferred embodiment the diameter is 11.75 inches. The diameter of the recess in the preferred embodiment is 10.875 inches, but may be between 10.75 inches and 11 inches.

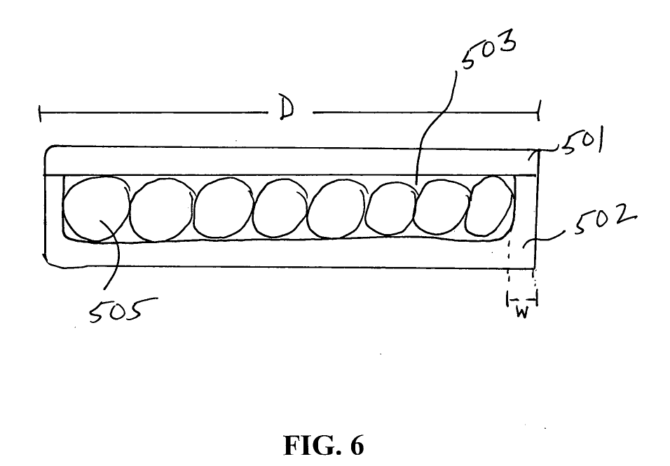

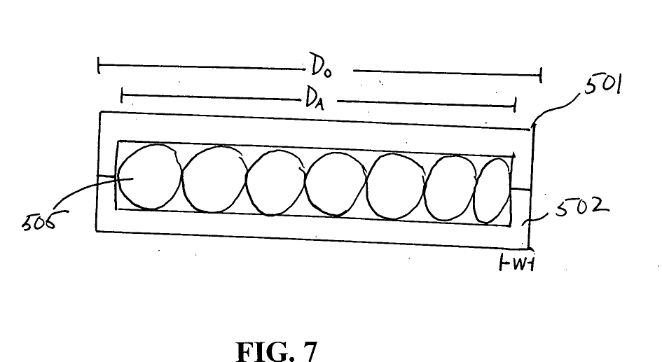

FIGS. 6 and 7 are sectional views of different embodiments of the luminous display device according to the present invention. More specifically, FIG. 6 is a sectional view illustrating a two plate design structure of a luminous display device, wherein one of the two plates, i.e., plate 502, is provided with a recess, and FIG. 7, the preferred embodiment, is a sectional view illustrating a two plate design structure of a luminous display device, wherein each of the two plates, i.e., plates 501 and 502, is provided with a recess. Using the preferred embodiment as illustrated in FIG. 7 is beneficial to the fabrication process in that a single mold can be used to create both plates 501 and 502.

Referring to FIGS. 6 and 7, a single layer of beads 505, which are preferably coated with a phosphorescent material, fills the interior recess portion 503. The diameter of each of the beads 505 substantially equals the height of the recess. Therefore, when the second plate 502 is fused to the first plate 501 to close the interior recess 503 and contain the layer of beads 505 between the two plates 501 and 502, both plates 501 and 502 are in substantial contact with beads 505, which prevent the plates 501 and 502 from collapsing upon themselves during manufacturing, particularly during the evacuation of the interior of the device prior to filling it with gas, and during use. The phosphorescent material will produce a desired color of the display device, or the beads 505 can be left uncoated when no color is desired. The layer of beads 505 help keep the outer surface plates 501 and 502 from collapsing, particularly during fabrication of the device, and when in use, maintain uniform spacing between the outer plates 501 and 502.

Although not shown, a hole is formed in one of the plates 501 and 502 for communicating with interior recess 503. The hole can be formed during molding of the rear glass, or by drilling thereafter. The assembled device is finally prepared for a suitable pump or equivalent device well known in the art to achieve the desired pressure within the interior recess 503.

The interior recess, now being pressurized, is filled with an ionizable gas and sealed. For example, the gas can be neon, argon, mercury vapor, or mixtures thereof.

An electrode (not shown) extends through one of the plates 501 and 502 and communicates with the interior recess and the ionizable gas. The electrode is generally centrally located on the axis of either plate 501 or 502, but may be positioned at other locations. A high frequency voltage applied to the electrode causes a lightning-like effect (506 in FIG. 4) as multiple discharge paths through the layer of beads 505 are viewable through the glass plates 501 and 502.

FIG. 4 is a top plan view of a luminous display device according to the present invention. As can be seen in FIG. 4, by constructing the luminous display device in accordance with the present invention, a size of an active display area 510 is much larger than in the devices in the prior art. More specifically, because in the preferred embodiment the outer rim 504 has a width (W) between the range of 0.35 to 0.6 inches, an inactive display area 511 is much smaller, leaving the remaining area of the device as the larger active display area 512.

In the preferred embodiment, as illustrated in FIG. 7, the diameter of the active display area, D_{A}, is at least 90% of the overall diameter, D_{O}, of the device. In addition, the surface area of the active display area, (A_{A}=Πrₐ²), is 75-80% of the overall surface area of the plates 501 and 502, (A_{O}=Πr₀²).

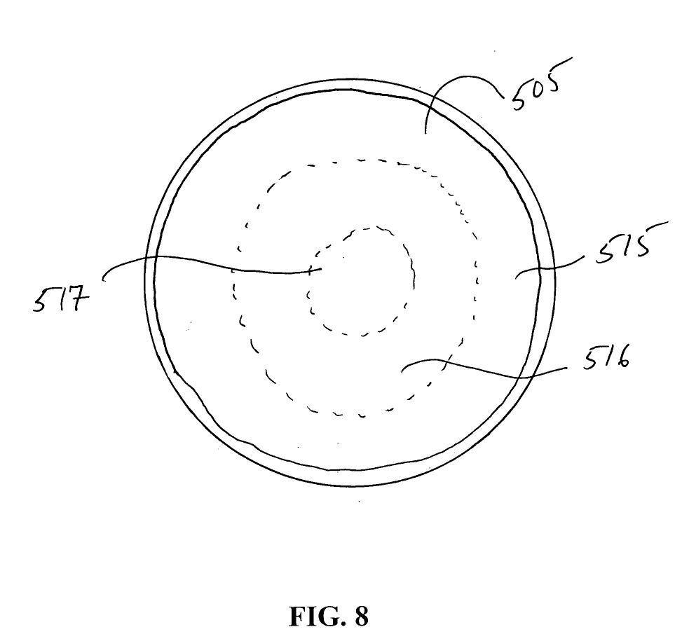

FIG. 8 is a top plan view illustrating a two plate design structure of a luminous display device according to the present invention including a layer of beads having different color phosphorescent coatings. Referring to FIG. 8, the layer of beads 505 includes a first ring 515, a second ring 516, and a third ring 517. Each of the rings 515-517 includes beads covered with a different color phosphorescent material, respectively. Therefore, as the high frequency voltage applied to the electrode causes a lightning-like effect 506 (as illustrated in FIG. 4) as multiple discharge paths through the layer of beads 505, the lightening-like 506 effect is viewable in different colors depending upon which ring it is traveling through.

As indicated above, FIG. 8 illustrates three different colored rings by way of example. Accordingly, it is also possible to use a different number of colors and different patterns for arranging the beads within the recess.

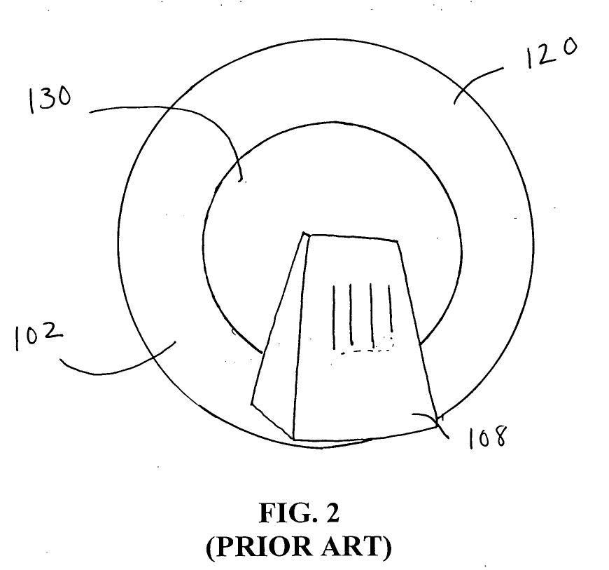

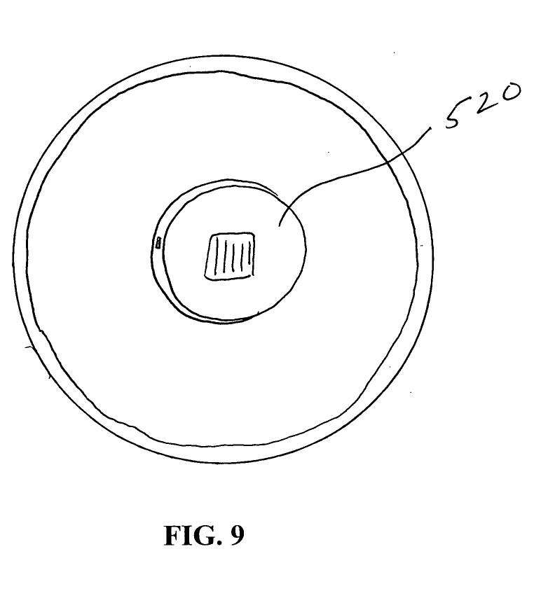

FIG. 9 is a rear view illustrating a housing of a power supply for use with a two plate design structure of a luminous display device according to the present invention. Referring to FIG. 9, the luminous display device according to the present invention includes a centrally located circular power source 520 for providing the high frequency voltage to the electrode. By shaping the housing of the power source 520 in a circular design, the luminous display device according to the present invention is provided with a more uniform appearance as well as increased non-muted display area. More specifically, the conventional power supply 108 housing as illustrated in FIG. 2 is shaped as a square or rectangle and covers an area from the center of the conventional device to the base. Because the plates of the conventional device and present invention are translucent, the power sources, although placed at the back of the devices, are viewable from the front. As result, the housing of the power source 520 according to the present invention, when seen through the plates from the front side, provides a more uniform design due to its being the same shape as and symmetrically centered on the plates 501 and 502.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. For example, while the present invention is illustrated in herein as having a circular shape, it is possible to create a luminous display device according to the present invention in a number of other shapes such as a square, a triangle, a star, etc.

1. A luminous display device with an increased active display area, comprising:
a first and second circular plates fused at an outer edge and having an overall diameter (D_{O});
a recess provided on an inner surface of at least one of the first and second plates to define an active display portion having a diameter (D_{A}) surrounded by an outer rim with a width (W);
a layer of beads held in position in the recess by the first and second fused plates and the outer rim;
an ionizable gas filling a volume of the recess around the layer of beads;
an electrode in communication with the ionizable gas; and
a power supply for providing a high frequency voltage applied to the electrode for creating a lightning-like effect, which is visible in the active display portion of the recess, in the ionizable gas as multiple discharge paths through the layer of beads;
wherein the diameter (D_{A}) of the active display is defined by D_{O}-2W and is at least 90% of the overall diameter (D_{O}).

2. The device as recited in claim 1, wherein the width (W) of the outer rim falls with in a range of 0.35 to 0.6 inches.

3. The device as recited in claim 1, wherein the layer of beads is coated with a colored phosphorescent material.

4. The device as recited in claim 1, wherein the layer of beads is coated with a plurality of colored phosphorescent materials.

5. The device as recited in claim 1, wherein a housing of the power supply has a circular shape.

6. The device as recited in claim 5, wherein the housing of the power supply is symmetrically fixed at a center of one of the first and second plates.

7. The device as recited in claim 1, wherein a diameter of each of the beads substantially equals a height of the recess.

8. The device as recited in claim 1, wherein each plate has a recess.

9. A method of providing a luminous display device with an increased active display area, comprising:
providing a first and second circular plates having an overall diameter (D_{O});
creating a recess on an inner surface of at least one of the first and second plates to define an active display portion having a diameter (D_{A}) surrounded by an outer rim with a width (W);
filling the recess with a layer of beads;
fusing the first and second plates to each other at an outer edge thereof;
filling a volume of the recess around the layer of beads with an ionizable gas;
installing an electrode in communication with the ionizable gas; and
providing a high frequency voltage applied to the electrode for creating a lightning-like effect, which is visible in the active display portion of the recess, in the ionizable gas as multiple discharge paths through the layer of beads;
wherein the diameter (D_{A}) of the active display is defined by D_{O}-2W and is at least 90% of the overall diameter D_{O}.

10. The method as recited in claim 9, wherein the width (W) of the outer rim falls with in a range of 0.35 to 0.6 inches.

11. The method as recited in claim 9, further comprising the step of coating the layer of beads with a colored phosphorescent material.

12. The method as recited in claim 9, further comprising the step of coating the layer of beads with a plurality of colored phosphorescent materials.

13. The method as recited in claim 9, further comprising the step of creating a recess in both plates.

14. A luminous display device with an increased active display area, comprising:
a first and second circular plates fused at an outer edge and having an overall radius (r₀);
a recess provided on an inner surface of at least one of the first and second plates to define an active display portion having a radius (rₐ) surrounded by an outer rim;
a layer of beads held in position in the recess by the first and second fused plates and the outer rim;
an ionizable gas filling a volume of the recess around the layer of beads;
an electrode in communication with the ionizable gas; and
a power supply for providing a high frequency voltage applied to the electrode for creating a lightning-like effect, which is visible in the active display portion of the recess, in the ionizable gas as multiple discharge paths through the layer of beads;
wherein the active display area is defined by (A_{A}=Πrₐ²) and is at least 75-80% of an overall display area defined by (A_{O}=Πrₒ²).

15. The device as recited in claim 14, wherein the layer of beads is coated with a colored phosphorescent material.

16. The device as recited in claim 14, wherein the layer of beads is coated with a plurality of colored phosphorescent materials.

17. The device as recited in claim 14, wherein a housing of the power supply has a circular shape.

18. The device as recited in claim 17, wherein the housing of the power supply is symmetrically fixed at a center of one of the first and second plates.

19. The device as recited in claim 1, wherein a diameter of each of the beads substantially equals a height of the recess.

20. The device as recited in claim 1, wherein each plate has a recess.
